(19) United States
(12) Patent Application Publication
(10) Pub. No.: US 2026/0136360 A1
(43) Pub. Date: May 14, 2026

(54) METHOD PERFORMED BY RECEIVER, WIRELESS COMMUNICATION DEVICE AND STORAGE MEDIUM

(71) Applicant: SAMSUNG ELECTRONICS CO., LTD., Suwon-si, Gyeonggi-do (KR)

(72) Inventors: Di SU, Beijing (CN); Chen QIAN, Beijing (CN); Peng LIN, Beijing (CN)

(21) Appl. No.: 19/121,100

(22) PCT Filed: Oct. 13, 2023
(86) PCT No.: PCT/KR2023/015855

§ 371 Date: Apr. 14, 2025

(30) Foreign Application Priority Data
Oct. 14, 2022 (CN) 202211261722.3

(51) Int. Cl. H04W 72/1268; H04L 27/26

(52) U.S. Cl. CPC H04W 72/1268; H04L 27/2634

(57) ABSTRACT

The present disclosure relates to a method performed by a receiver, a wireless communication device and a storage medium. The method includes: receiving a first signal, and obtaining multiple second signals based on the received first signal; performing non-linear compensation for the multiple second signals based on a neural network to obtain a third signal; obtaining data bits based on the third signal; wherein a structure of the neural network is determined based on transmission configuration information associated with the first signal.

### TECHNICAL FIELD

The present disclosure relates to a communication field and, specifically, to a method performed by a receiver in a wireless communication system, a wireless communication device and a storage medium.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network per-formances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beam forming, massive multiple-input multiple-output (MIMO), full-dimensional MIMO (FD-MIMO), array antenna, analog beam forming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window su-perposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Solution to Problem

According to a first aspect of the embodiments of the present disclosure, there is proposed a method performed by a receiver in a wireless communication system, including: receiving a first signal, and obtaining multiple second signals based on the received first signal; performing non-linear compensation for the multiple second signals based on a neural network to obtain a third signal; obtaining data bits based on the third signal; wherein a structure of the neural network is determined based on transmission configuration parameter(s) associated with the first signal.

Alternatively, the method further includes: determining the structure of the neural network based on the transmission configuration parameter(s) associated with the first signal, wherein the performing of the non-linear compensation for the multiple second signals based on the neural network to obtain the third signal includes: performing the non-linear compensation for the multiple second signals by using the neural network with the determined structure, to obtain the third signal.

Alternatively, the structure of the neural network includes at least one of: the number of neural networks, the number of middle layers of the neural network, the number of neurons of the middle layer of the neural network, and a buffer length of input data of the neural network.

Alternatively, the transmission configuration parameter(s) includes at least one of: a system bandwidth for uplink, a subcarrier spacing for uplink, the number of Fast Fourier Transform (FFT) points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment.

Alternatively, the transmission configuration parameter(s) includes at least one of: a system bandwidth for downlink, a subcarrier spacing for downlink, the number of Fast Fourier Transform (FFT) points for downlink, the number of layers/antenna ports configured to downlink transmission for a user equipment, the number of physical resource blocks configured to downlink transmission for a user equipment, a modulation scheme configured to downlink transmission for a user equipment.

Alternatively, the determining of the structure of the neural network based on the transmission configuration parameter(s) associated with the first signal includes: determining the structure of the neural network based on the transmission configuration parameter(s) when at least one of the following conditions is satisfied: the system bandwidth for uplink satisfies a first predetermined value requirement; the subcarrier spacing for uplink satisfies a second predetermined value requirement; the number of the FFT points for uplink satisfies a third predetermined value requirement; the number of users with uplink transmissions on a same time unit satisfies a fourth predetermined value requirement; the number of the layers/antenna ports configured to uplink transmission for the at least one user equipment satisfies a fifth predetermined value requirement; the number of the physical resource blocks allocated to uplink transmission for the at least one user equipment satisfies a sixth predetermined value requirement; a modulation order of the modulation scheme configured to uplink transmission for the at least one user equipment satisfies a seventh predetermined value requirement.

Alternatively, the determining of the structure of the neural network based on the transmission configuration parameter(s) associated with the first signal includes: adjusting the structure of the neural network according to the transmission configuration parameter(s) when at least one of the following conditions is satisfied: the system bandwidth for downlink satisfies an eighth predetermined value requirement; the subcarrier spacing for downlink satisfies a ninth predetermined value requirement; the number of the FFT points for downlink satisfies a tenth predetermined value requirement; the number of the layers/antenna ports configured to downlink transmission for the user equipment satisfies an eleventh predefined value requirement; the number of the physical resource blocks allocated to downlink transmission for the user equipment satisfies a twelfth predetermined value requirement; a modulation order of the modulation scheme configured to downlink transmission for the user equipment satisfies a thirteenth predefined value requirement.

Alternatively, the neural network includes an input layer, the middle layer, and an output layer, wherein the method further includes: determining an input matrix of the input layer and/or a transition matrix of the middle layer; wherein the determining of the input matrix of the input layer and/or the transition matrix of the middle layer includes at least one of: selecting, according to the determined number of the neurons of the middle layer of the neural network and/or the buffer length of the input data, one of pre-stored input matrices and/or transition matrices as the input matrix of the input layer and/or the transition matrix of the middle layer of the neural network; intercepting, according to the determined number of the neurons of the middle layer of the neural network and/or the buffer length of the input data, some elements from the pre-stored input matrices and/or transition matrices to obtain the input matrix of the input layer and/or the transition matrix of the middle layer of the neural network; obtaining the input matrix of the input layer and/or the transition matrix of the middle layer of the neural network by transforming and/or stitching a pre-stored base matrix, according to the determined number of the neurons of the middle layer of the neural network and/or the buffer length of the input data.

Alternatively, the neural network includes a plurality of parallel neural networks, wherein when the multiple second signals are uplink signals of different uplink transmission layers of different user equipments, the uplink signal of each uplink transmission layer of different user equipments is performed the non-linear compensation by different parallel neural networks respectively, or the uplink signals of all uplink transmission layers of each user equipment are performed the non-linear compensation by a same parallel neural network, or the uplink signals of a same modulation scheme of different transmission layers for uplink of different user equipments are performed the non-linear compensation by the same parallel neural network; when the multiple second signals are downlink signals of different downlink transmission layers of a same user equipment, the downlink signal of each downlink transmission layer of the same user equipment is performed the non-linear compensation by different parallel neural networks respectively, or the downlink signals of a same modulation scheme of different transmission layers for downlink of the same user equipment are performed the non-linear compensation by the same parallel neural network.

Alternatively, the neural network includes a plurality of parallel neural networks, wherein an output of at least one parallel neural network is used as an input of another parallel neural network; or an input of each parallel neural network is at least one second signal of the multiple second signals, the at least one second signal being input to two different parallel neural networks.

Alternatively, the transmission configuration parameter(s) includes at least one of: a system bandwidth for side link, a subcarrier spacing for side link, the number of fast Fourier transform (FFT) points for side link, the number of layers/antenna ports configured to side link transmission for a side link user equipment, the number of physical resource blocks configured to side link transmission for a side link user equipment and a modulation scheme configured to side link transmission for a side link user equipment.

According to a second aspect of the embodiments of the present disclosure, there is proposed a wireless communication device, including: a transceiver; and at least one controller coupled to the transceiver and configured to perform the following op-crations of: receiving a first signal, and obtaining multiple second signals based on the received first signal; performing non-linear compensation for the multiple second signals based on a neural network to obtain a third signal; obtaining data bits based on the third signal; wherein a structure of the neural network is determined based on transmission configuration parameter(s) associated with the first signal.

Alternatively, the at least one controller is further configured to determine the structure of the neural network based on the transmission configuration parameter(s) associated with the first signal, wherein the performing of the non-linear compensation for the multiple second signals based on the neural network to obtain the third signal includes: performing the non-linear compensation for the multiple second signals by using the neural network with the determined structure, to obtain the third signal.

Alternatively, the structure of the neural network includes at least one of: the number of neural networks, the number of middle layers of the neural network, the number of neurons of the middle layer of the neural network, and a buffer length of input data of the neural network.

Alternatively, the transmission configuration parameter(s) includes at least one of: a system bandwidth for uplink, a subcarrier spacing for uplink, the number of Fast Fourier Transform (FFT) points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment.

Alternatively, the transmission configuration parameter(s) includes at least one of: a system bandwidth for downlink, a subcarrier spacing for downlink, the number of Fast Fourier Transform (FFT) points for downlink, the number of layers/antenna ports configured to downlink transmission for a user equipment, the number of physical resource blocks configured to downlink transmission for a user equipment, a modulation scheme configured to downlink transmission for a user equipment.

Alternatively, the determining of the structure of the neural network based on the transmission configuration parameter(s) associated with the first signal includes: determining the structure of the neural network based on the transmission configuration parameter(s) when at least one of the following conditions is satisfied: the system bandwidth for uplink satisfies a first predetermined value requirement; the subcarrier spacing for uplink satisfies a second predetermined value requirement; the number of the FFT points for uplink satisfies a third predetermined value requirement; the number of users with uplink transmissions on a same time unit satisfies a fourth predetermined value requirement; the number of the layers/antenna ports configured to uplink transmission for the at least one user equipment satisfies a fifth predetermined value requirement; the number of the physical resource blocks allocated to uplink transmission for the at least one user equipment satisfies a sixth predetermined value requirement; a modulation order of the modulation scheme configured to uplink transmission for the at least one user equipment satisfies a seventh predetermined value requirement.

Alternatively, the determining of the structure of the neural network based on the transmission configuration parameter(s) associated with the first signal includes: adjusting the structure of the neural network according to the transmission configuration parameter(s) when at least one of the following conditions is satisfied: the system bandwidth for downlink satisfies an eighth predetermined value requirement; the subcarrier spacing for downlink satisfies a ninth predetermined value requirement; the number of the FFT points for downlink satisfies a tenth predetermined value requirement; the number of the layers/antenna ports configured to downlink transmission for the user equipment satisfies an eleventh predefined value requirement; the number of the physical resource blocks allocated to downlink transmission for the user equipment satisfies a twelfth predetermined value requirement; a modulation order of the modulation scheme configured to downlink transmission for the user equipment satisfies a thirteenth predefined value requirement.

Alternatively, the neural network includes an input layer, the middle layer, and an output layer, wherein the at least one controller is further configured to: determine an input matrix of the input layer and/or a transition matrix of the middle layer; wherein the determining of the input matrix of the input layer and/or the transition matrix of the middle layer includes at least one of: selecting, according to the determined number of the neurons of the middle layer of the neural network and/or the buffer length of the input data, one of pre-stored input matrices and/or transition matrices as the input matrix of the input layer and/or the transition matrix of the middle layer of the neural network; intercepting, according to the determined number of the neurons of the middle layer of the neural network and/or the buffer length of the input data, some elements from the pre-stored input matrices and/or transition matrices to obtain the input matrix of the input layer and/or the transition matrix of the middle layer of the neural network; obtaining the input matrix of the input layer and/or the transition matrix of the middle layer of the neural network by transforming and/or stitching a pre-stored base matrix, according to the determined number of the neurons of the middle layer of the neural network and/or the buffer length of the input data.

Alternatively, the neural network includes a plurality of parallel neural networks, wherein when the multiple second signals are uplink signals of different uplink transmission layers of different user equipments, the uplink signal of each uplink transmission layer of different user equipments is performed the non-linear compensation by different parallel neural networks respectively, or the uplink signals of all uplink transmission layers of each user equipment are performed the non-linear compensation by a same parallel neural network, or the uplink signals of a same modulation scheme of different transmission layers for uplink of different user equipments are performed the non-linear compensation by the same parallel neural network; when the multiple second signals are downlink signals of different downlink transmission layers of a same user equipment, the downlink signal of each downlink transmission layer of the same user equipment is performed the non-linear compensation by different parallel neural networks respectively, or the downlink signals of a same modulation scheme of different transmission layers for downlink of the same user equipment are performed the non-linear compensation by the same parallel neural network.

Alternatively, the neural network includes a plurality of parallel neural networks, wherein an output of at least one parallel neural network is used as an input of another parallel neural network; or an input of each parallel neural network is at least one second signal of the multiple second signals, the at least one second signal being input to two different parallel neural networks.

Alternatively, the transmission configuration parameter(s) includes at least one of: a system bandwidth for side link, a subcarrier spacing for side link, the number of fast Fourier transform (FFT) points for side link, the number of layers/antenna ports configured to side link transmission for a side link user equipment, the number of physical resource blocks configured to side link transmission for a side link user equipment and a modulation scheme configured to side link transmission for a side link user equipment.

According to a third aspect of the embodiments of the present disclosure, there is proposed a computer readable storage medium storing instructions, wherein the instructions, when run by at least one processor, cause the at least one processor to perform the above method.

The technical solutions provided by the embodiments of the present disclosure brings at least the following beneficial effects: self-adaption of the structure of the neural network may be realized since the structure of the neural network may be determined according to the transmission configuration parameter(s) related to the signals received by the wireless communication device, so as to achieve a reasonable compromise between the complexity and performance of the neural network, and avoid reduction of the neural network performance caused by training overfitting.

It should be understood that the above general descriptions and the following detailed descriptions are only illustrative and explanatory, and do not limit the present disclosure.

### BRIEF DESCRIPTION OF DRAWINGS

The accompanying drawings herein are incorporated into the specification and form a part of the specification, showing exemplary embodiments in accordance with the present disclosure and used together with the specification to explain the principles of the present disclosure, and do not constitute an improper limitation of the present disclosure.

FIG. 1 illustrates an example wireless network 100 according to various embodiments of the present disclosure;

FIG. 2a and FIG. 2b illustrate an example wireless transmission path and an example wireless reception path according to the present disclosure;

FIG. 3a illustrates an example UE 116 according to the present disclosure;

FIG. 3b illustrates an example gNB 102 according to the present disclosure;

FIG. 4a illustrates a schematic diagram of a base station receiver for performing non-linear compensation based on a neural network;

FIG. 4b illustrates a schematic diagram of a structure of a neural network for non-linear compensation in the base station receiver showed in FIG. 4a;

FIG. 5 illustrates a flowchart of a wireless communication method according to an embodiment of the present disclosure;

FIG. 6 illustrates a schematic diagram of a base station side receiver where each layer of uplink signals from different users is processed by different parallel neural networks, respectively;

FIG. 7 illustrates a schematic diagram of a parallel neural network with a feedback link;

FIG. 8 illustrates a schematic diagram of parallel neural networks with input data splitting and multiplexing;

FIG. 9 illustrates a block diagram of a wireless communication device according to an embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which may be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The exemplary embodiments of the present disclosure are further described below in conjunction with the accompanying drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples may be made without departing from the scope of the present disclosure.

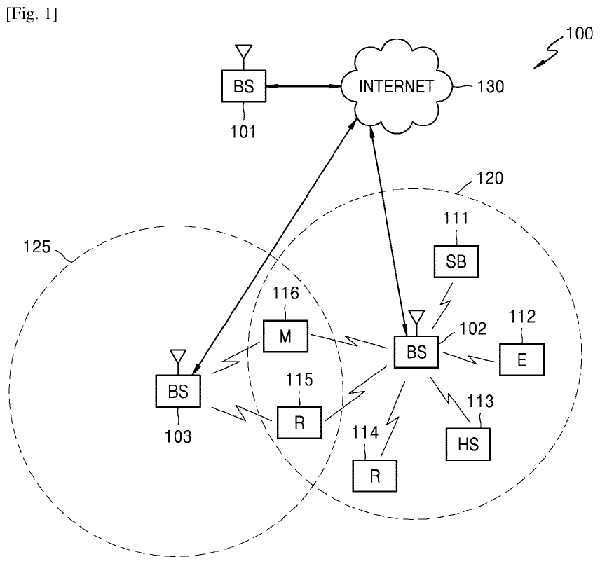

FIG. 1 illustrates an example wireless network 100 according to various embodiments of the present disclosure. The embodiment of the wireless network 100 shown in FIG. 1 is for illustration only. Other embodiments of the wireless network 100 may be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

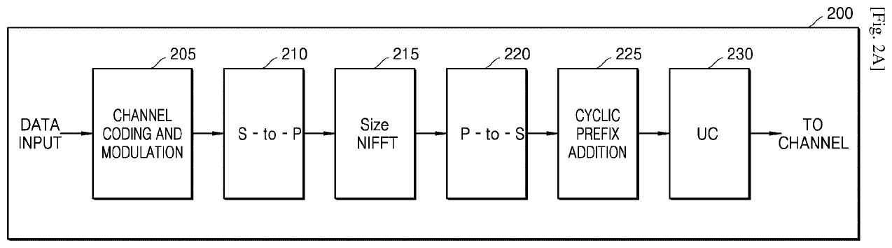

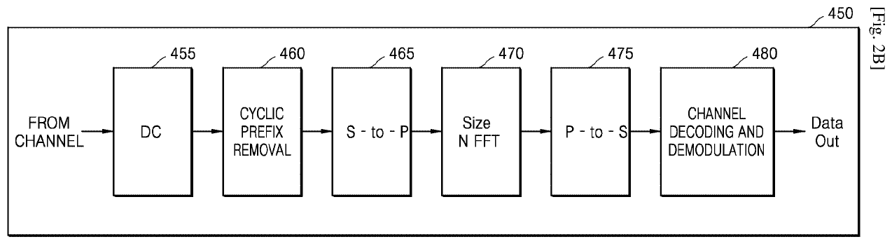

FIGS. 2a and 2b illustrate example wireless transmission and reception paths according to the present disclosure. In the following description, the transmission path 200 may be described as being implemented in a gNB, such as gNB 102, and the reception path 250 may be described as being implemented in a UE, such as UE 116. However, it should be understood that the reception path 250 may be implemented in a gNB and the transmission path 200 may be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b may be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b may be combined, further subdivided or omitted, and additional components may be added according to specific requirements. Furthermore, FIGS. 2a and 2b are intended to illustrate examples of types of transmission and reception paths that may be used in a wireless network. Any other suitable architecture may be used to support wireless communication in a wireless network.

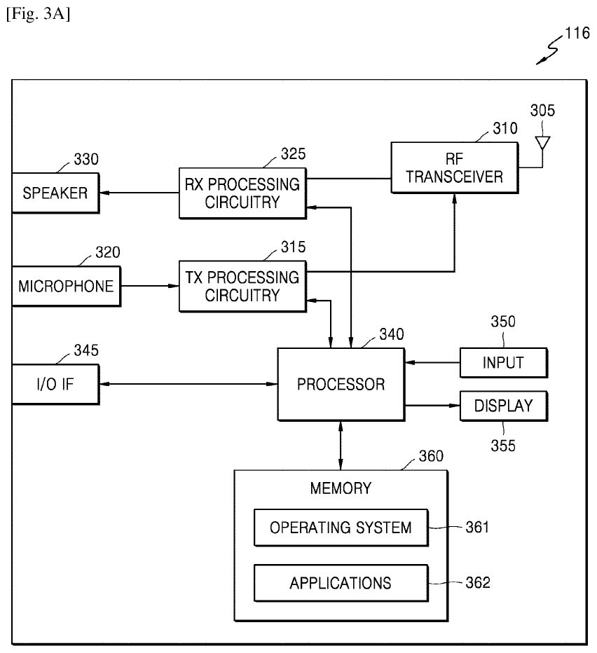

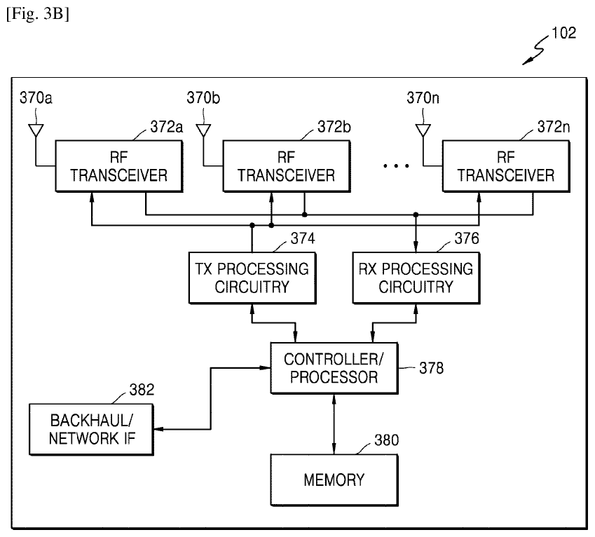

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these ac-cessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes may be made to FIG. 3a. For example, various components in FIG. 3a may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3a illustrates that the UE 116 is configured as a mobile phone or a smart phone, UEs may be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

As wireless communication networks become more and more popular and evolve, various applications emerge and users demand a higher rate of communication. To meet this requirement, one approach is to use higher-order modulation, such as supporting 256 QAM in existing NR and LTE systems. However, the use of high-order modulation inevitably increases a peak-to-average power ratio of a transmitted signal, which may cause non-linear distortion of the transmitted signal when a transmitting power is high, thus affecting the receiving performance. Considering the difference in manufacturing cost and size constraint between a terminal device and a base station device, the performance of hardware such as a power amplifier used in terminal is often inferior to that used in a base station, so this non-linear distortion of the transmitted signal is more serious for uplink transmission.

At present, an EVM requirement (EVM may measure the degree of signal distortion) that should be satisfied by a signal of each modulation scheme sent by a terminal is set in the protocol. When the terminal adopts a higher-order modulation scheme to send a signal, the following situation may occur: the transmitting power of the signal at the terminal side has not yet reached the rated transmitting power, but the actual EVM fails to meet the EVM requirement specified in the protocol, which means that when the higher-order modulation scheme is adopted, the terminal cannot send uplink signals according to the rated power, and the transmitting power is always less than the rated power, thus causing the loss of uplink coverage.

Some studies now consider improving receiver performance to improve this problem, for example, a neural network-based receiver is used. If non-linear features of training data of a neural network are the same as actual received data, theoretically, the neural network-based receiver may handle reception of a non-linear distorted transmitted signal, thus lowing the EVM requirement of the transmitted signal and improving the coverage.

For example, the receiver may use a neural network based on an Echo State Network (ESN) to compensate for the non-linear part of the transmitted signal, and the demodulation performance at the receiver side may be significantly improved compared with that no neural network is used to handle the non-linear distortion of the transmitted signal.

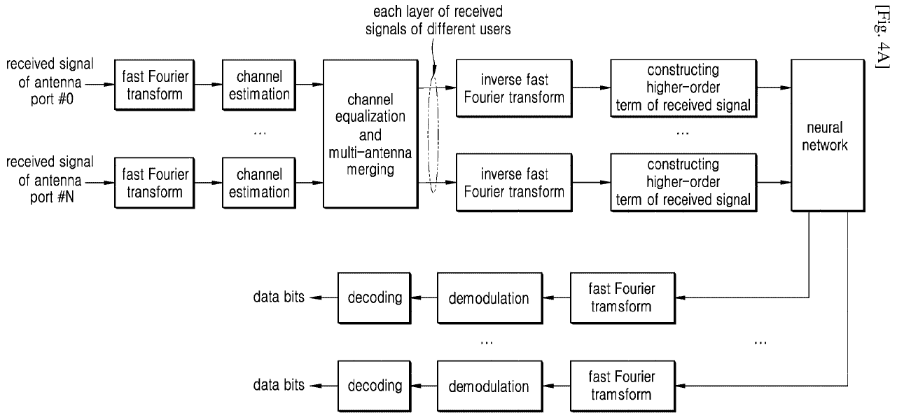

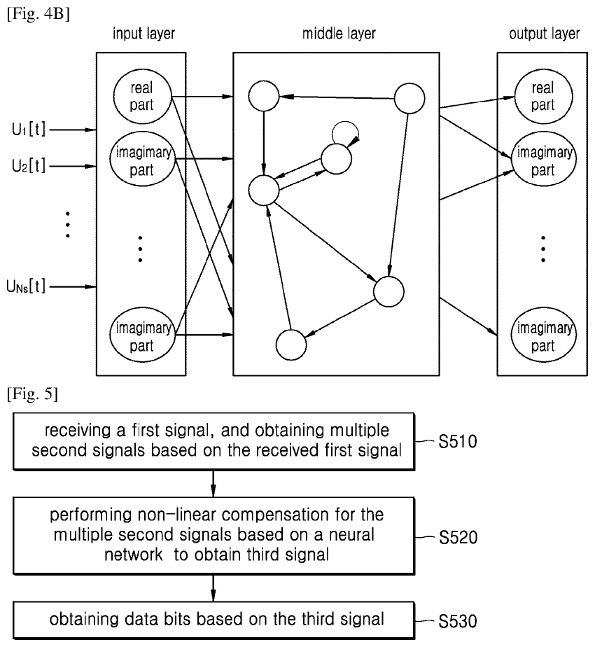

A schematic diagram of a base station receiver for performing non-linear compensation based on a neural network is given in FIG. 4a. It is assumed that the base station receives uplink signals from a total of N antenna ports, where the received uplink signals may include uplink signals from multiple users.

Firstly, the received signal (time domain) of each antenna port is transformed into a frequency domain signal by fast Fourier transform and then channel estimation is performed separately; after that, channel equalization and multi-antenna merging is performed, and the received signals of different layers of different users may be output, where the received signal of any layer of any user is used as one data stream, and each data stream is transformed into a time domain signal by inverse fast Fourier transform respectively; then, each time domain signal is constructed as a higher-order term, for example, each higher-order term of the i-th signal may be constructed as

$${u}_{i}^{p} [ t ] = {u}_{i} [ t ] {\vert {u}_{i} [ t ] \vert}^{p - 1} ,$$

p=1,3,5, . . . , P; i=1,2, . . . , Nₛ respectively, Nₛ denotes the number of data streams uplink received by the base station. (e.g., different layers of different users are independent data streams), P is the order of the highest order term constructed, and further data caching is performed for each order term, then the output signal of a module of “constructing a higher-order term of a received signal” may be written as

$${u}_{i} [ t ] = [ {u}_{i} [ t - ( {L}_{i n} - 1 ) ] , … , {u}_{i} [ t ] , {u}_{i}^{3} [ t - ( {L}_{i n} - 1 ) ] , … , {u}_{i}^{3} [ t ] , … ] ] ,$$

where uᵢ[t]∈ [symbol] ^{PL}^{ᵢₙ}^{×1} is a complex-valued vector and Lᵢₙ is a buffer length of input data of a neural network, i.e., the constructed higher-order term of each signal is input to the neural network after undergoing the cache of the length Lᵢₙ; the neural network processes the input signal, outputs the time domain received signal after non-linear compensation, and then each signal undergoes fast Fourier transform to a frequency domain received signal, and then undergoes demodulation and decoding in turn to obtain required data bits.

FIG. 4b gives a schematic diagram of a structure of a neural network for non-linear compensation in the above base station receiver, using an ESN as an example. As mentioned before, the input signals of the neural network may comprise multiple data streams (e.g., different layers from different users), each of which is a higher-order term signal uᵢ[t], i=1, . . . , Nₛ constructed from the time domain received signal after equalization, where each data stream includes the 1st-order term and several higher-order terms of that received signal, respectively, and each complex-valued signal of each data stream needs to be split into real and imaginary parts to match the data processing method of the existing ESN.

Then, the input data is transformed by an input matrix of an input layer as an input of an middle layer, and the processing of its input data by the middle layer generally involves a variety of complex operations on the input vector that may generate a state vector of the middle layer, which may include, for example, matrix transformation (e.g., a state matrix of the middle layer) of the input data or non-linear function operations (e.g., hyperbolic tangent function tanh, etc.).

An example of the state vector of output from the middle layer is: x[t]=tanh(Wᵢₙ·u[t]+Wᵣₑₛ·x[t−1]), where x[t] denotes a state vector of the middle layer at moment t, Wᵢₙ denotes the input matrix of the input layer, u[t] denotes the input vector, and Wᵣₑₛ denotes a transition matrix of the middle layer.

Finally, the state vector output from the middle layer is used as the input of the output layer of the neural network, and the matrix transformation (e.g., dimension reduction) of the state vector of the middle layer is performed by the output layer, and the final output of the time domain received signal at moment t after the non-linear compensation and the equalization is y[t]=Wₒᵤₜ·x [t], where y[t] is the output result of the ESN, Wₒᵤₜ is the output matrix of the output layer. To simplify the complexity of training for the ESN, in practice, the input layer and middle layer are often fixed, and only the output matrix of the output layer is trained.

In practical processing, the received signal at moment t processed by the neural network may be a received signal of multiple sampling points within the time unit including the moment t. For example, the neural network performs the non-linear compensation for the time domain received signal of all N_{FFT} sampling points within an OFDM symbol, where N_{FFT} is the number of FFT points, i.e., each item in each input data uᵢ[t] of the input layer of the neural network is a vector with a length of N_{FFT}, taking uᵢ[t] as an example, uᵢ[t]∈ [symbol] ^{1×N}^{_{FFT}} is a vector, then the dimension of each data stream uᵢ[t] is PLᵢₙ×N_{FFT} at this time.

It may be predicted that when the amount of the input data of the neural network becomes larger (higher dimension), the structure of the neural network needs to be designed more complex to deal with this situation, for example, increasing the number of neurons of the middle layer, the number of middle layers, the depth of the middle layer, etc.

Unfortunately, however, in the related art, the receiver based on the neural network for non-linear compensation usually uses a fixed structure of the neural network, which cannot be widely applied to receiver designs under configurable transmission conditions in real communication systems, including but not limited to, multi-user multi-stream configurations, multiple modulation scheme configurations, etc.

The present disclosure proposes a wireless communication method, which may determine the structure of the neural network based on transmission configuration parameter(s) associated with signals received by a wireless communication device (e.g., a receiver, a wireless communication device including the receiver, or a communication node), and achieve self-adaption of the neural network structure, thereby achieving a reasonable compromise between the complexity and performance of the neural network, as well as avoiding degradation of the neural network performance caused by training overfitting. For example, the method may be applied to a base station side receiver, a terminal side receiver, a side link device side receiver, or a receiver of a relay node in a communication link.

FIG. 5 illustrates a flowchart of a method performed by a receiver in a wireless communication system according to an embodiment of the present disclosure.

Referring to FIG. 5, at step S510, a first signal is received, and multiple second signals are acquired based on the received first signal. According to an embodiment, as shown in FIG. 4a, the first signal may comprise a received signal from an antenna port of a wireless communication device, e.g., uplink signals from a plurality of user equipments, or a downlink signal from a base station, or a signal received by a side link device, etc. The multiple second signals may comprise, for example, output signals after the module of “constructing a higher-order term of a received signal” mentioned above.

For example, the multiple second signals may be obtained based on the first signal by the following method: a fast Fourier transform is performed on a received signal to obtain a frequency domain signal, a channel estimation is performed based on the obtained frequency domain signal, a channel equalization and multi-antenna merging is performed on the channel estimation result, and then an inverse fast Fourier transform is performed on the result of the channel equalization and multi-antenna merging to obtain multiple time domain signals, and a higher-order term is constructed for each time domain signal respectively, to obtain the multiple second signals.

For example, when the receiver is located at a base station side, a way to obtain the multiple second signals based on the received first signal may be as depicted in FIG. 4a, which is not repeated here. The specific way of acquiring the multiple second signals based on the received first signal is not limited to the above examples, and the present disclosure is not limited in this regard.

At step S520, a third signal is obtained by performing non-linear compensation for the multiple second signals based on a neural network. For example, the non-linear compensation for the multiple second signals may be performed in the manner depicted in FIG. 4b. Although FIG. 4b depicts the non-linear compensation operation using a neural network for non-linear compensation in a base station receiver as an example, the non-linear compensation manner described with reference to FIG. 4b is not limited to application to the base station receiver, but may be applied to any receiver for performing the non-linear compensation based on the neural network. As an example, the neural network may be an ESN or a neural network constructed based on the ESN, but is not limited thereto.

At step S530, data bits are obtained based on the third signal. The third signal may comprise a time domain signal after the non-linear compensation, and a frequency domain signal may be obtained by performing a fast Fourier transform on the third signal, and then the data bits are obtained by demodulating and decoding the frequency domain signal.

As mentioned above, in the related art, a receiver using a neural network for non-linear compensation usually uses a neural network with a fixed-structure, which cannot be widely applied to receiver designs under configurable transmission conditions in actual communication systems.

For this purpose, the present disclosure proposes that a structure of the neural network may be determined based on transmission configuration parameter(s) associated with the first signal. Since the structure of the neural network may be determined based on the transmission configuration parameter(s) associated with the received signal, self-adaption of the structure of the neural network may be realized, thereby achieving a reasonable compromise between the complexity and performance of the neural network and avoiding reduction of the neural network performance caused by training overfitting.

For example, selection of a structure of an middle layer of the neural network considers features of input signal(s) of the neural network (i.e., the multiple second signals in the context). The structure of the middle layer determines the performance and complexity of the neural network and should match the characteristics of the signals to be processed.

For example, if non-linear features of the input multiple second signals are strongly correlated (e.g., belong to different data streams of a same user equipment), the number of neurons in the middle layer should be reduced appropriately, otherwise it not only increases the complexity of the neural network, but also leads to the training overfitting that affects the performance of the neural network;

furthermore, if the non-linear features of the input data stream are complex (e.g., if a bandwidth of the frequency domain received signal corresponding to that data stream is large, the non-linear features have frequency selection characteristic, and/or if a modulation order corresponding to that data stream increases, the non-linear features are more complex), the number of neurons in the middle layer should be increased appropriately, otherwise the neural network is too simple to match the complexity of the problem to be solved and cannot achieve the expected performance.

According to an embodiment, the structure of the neural network may include at least one of the following items: the number of neural networks, the number of middle layers (or hidden layers, hereinafter referred to as middle layers) of the neural network, the number of neurons in the middle layer of the neural network, and a buffer length of input data of the neural network.

For example, the neural network may be located in a base station-side receiver, or may be located in a terminal-side receiver, or may be located in a receiver of a side link device, or may be located in a receiver of a relay node of a communication link. Here, the buffer length of the input data of the neural network may refer to that a length of a cache through which the input data of the neural network passes before being input into the neural network.

For example, the transmission configuration parameter(s) may include at least one of a system bandwidth for uplink, a subcarrier spacing for uplink, the number of Fast Fourier Transform (FFT) points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment. According to an cm-bodiment of this disclosure, the at least one user equipment described above may be all user equipments or a portion of all user equipments. For example, when the receiver performing the method shown in FIG. 5 is a base station side receiver, the transmission configuration parameter(s) may include at least one of the above.

For another example, the transmission configuration parameter(s) may include at least one of a system bandwidth for downlink, a subcarrier spacing for downlink, the number of Fast Fourier Transform (FFT) points for downlink, the number of layers/antenna ports to downlink transmission configured for a user equipment, the number of physical resource blocks configured to downlink transmission for a user equipment, a modulation scheme configured to downlink transmission for a user equipment. For example, when the receiver performing the method shown in FIG. 5 is a user equipment side receiver, the transmission configuration parameter(s) may include at least one of the above.

Further yet another example, the transmission configuration parameter(s) may include at least one of a system bandwidth for side link, a subcarrier spacing for side link, the number of fast Fourier transform (FFT) points for side link, the number of layers/antenna ports configured to side link transmission for a side link user equipment, the number of physical resource blocks configured to side link transmission for a side link user equipment and a modulation scheme configured toside link transmission for a side link user equipment. For example, when the receiver performing the method shown in FIG. 5 is a side link device side receiver, the transmission configuration parameter(s) may include at least one of the above.

According to an embodiment, the transmission configuration parameter(s) may be configured by a base station and the transmission configuration parameter(s) may be sent to a user equipment after being configured by the base station, or the transmission configuration parameter(s) may be configured by a side link device. For example, the base station may change the configured transmission configuration parameter(s) based on communication states or communication conditions, etc.

According to an embodiment, the method shown in FIG. 5 further includes determining a structure of the neural network based on the transmission configuration parameter(s) associated with the first signal. For example, determining the structure of the neural network includes determining the structure of the neural network based on the transmission configuration parameter(s) before using the neural network, or adjusting the structure of the neural network based on the transmission configuration parameter(s) during the use of the neural network. Accordingly, step S520 may include: performing the non-linear compensation for the multiple second signals by using the neural network with the determined structure, to obtain a third signal.

Taking that the receiver performing the above method is a base station side receiver as an example, a specific example of determining the structure of a neural network based on the transmission configuration parameter(s) is to determine the number of cascaded neural networks, and/or the number of middle layers of the neural network, and/or the number of neurons of the middle layer of the neural network, and/or a buffer length of input data based on one or more of the following transmission configuration parameter(s):

a system bandwidth for uplink, a subcarrier spacing for uplink, the number of FFT points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment.

Wherein, determining the number of middle layers of the neural network means at least including determining the number of cascaded middle layer networks of the neural network; the cascaded neural networks mean that an output of a neural network of a previous level is used as an input to a neural network of a subsequent level to form the cascaded neural networks. According to an embodiment of this disclosure, the output of the neural network of the previous level in the cascaded neural networks is used as part of the input of the neural network of the subsequent level, or, part of the output of the neural network of the subsequent level is used as feedback information of the neural network of the previous level.

Theoretically, the neural network may be made more complex by increasing the number of cascaded neural networks, the number of middle layers of the neural network, and the number of neurons in the middle layer, etc., to increase the capacity of the neural network to process complex data, and the structural complexity of the neural network should match the complexity of the processing problem.

This design of adaptively adjusting the structure of the neural network according to the transmission configuration parameter(s) allows the neural network to adjust the network structure settings autonomously according to the complexity of the data to be processed, so that the performance of the neural network matches the complexity as well as avoiding the performance loss caused by the training overfitting.

For example, the increase of FFT points for uplink/increase of a system bandwidth for uplink/reduction of an uplink subcarrier interval means that the amount of data per input data of the neural network increases, while the increase of the number of layers/antenna ports configured to uplink transmission for the user equipment means that the number of multiple input data of the neural network increases, both of which mean that the amount of input data of the neural network increases, and then the neural network should be adjusted to increase the number of middle layers or increase the number of neurons in the middle layer, so as to deal with the non-linear compensation for larger data amount;

for another example, the number of users with uplink transmissions on a same time unit increases, and the input data belonging to different users may have different non-linear features, so it not only increases the input data amount of the neural network, but also means that the complexity of the data to be processed by the neural network increases, then the number of neurons of the middle layer should be increased or the number of middle layers should be increased at least accordingly, so as to deal with the non-linear compensation for more complex and more data;

for yet another example, the number of physical resource blocks configured to uplink transmission for the user equipment reduces, it means that the non-linear feature of the input data of the neural network are simplified (the frequency selection characteristics are not obvious), then the number of neurons of the middle layer or the number of the middle layers of the neural network should be reduced accordingly, which may reduce the computational complexity of the neural network while avoiding the performance loss caused by the training overfitting.

Specifically, particular value(s) or a combination of the particular value(s) of the transmission configuration parameter(s) is associated with particular neural network structure settings. According to an embodiment, the determining of the structure of the neural network according to the transmission configuration parameter(s) associated with the first signal mentioned above may include:

determining the structure of the neural network based on the transmission configuration parameter(s) when at least one of the following conditions is satisfied: the system bandwidth for uplink satisfies a first predetermined value requirement; the subcarrier spacing for uplink satisfies a second predetermined value requirement; the number of the FFT points for uplink satisfies a third predetermined value requirement; the number of users with uplink transmissions on a same time unit satisfies a fourth predetermined value requirement; the number of the layers/antenna ports configured to uplink transmission for the at least one user equipment satisfies a fifth predetermined value requirement; the number of the physical resource blocks allocated to uplink transmission for the at least one user equipment satisfies a sixth predetermined value requirement; a modulation order of the modulation scheme configured to uplink transmission for the at least one user equipment satisfies a seventh predetermined value requirement.

For example, in a case where the neural network is located in a base station side receiver, the number of middle layers of the neural network is increased, and/or the number of neurons in the middle layer of the neural network is increased, and/or the buffer length of the input data is increased according to the transmission configuration parameter(s) when the transmission configuration parameter(s) satisfy at least one of the following conditions: the system bandwidth for uplink is increased to reach the first predetermined value requirement; the subcarrier spacing for uplink is reduced to reach the second predetermined value requirement; the number of the FFT points for uplink is increased to reach the third predetermined value requirement; the number of users with uplink transmissions on a same time unit is increased to reach the fourth predetermined value requirement; the number of the layers/antenna ports to uplink transmission configured for the at least one user equipment is increased to reach the fifth predetermined value requirement; the number of the physical resource blocks allocated to uplink transmission for the at least one user equipment is increased to reach the sixth predetermined value requirement; the modulation order of the modulation scheme configured to uplink transmission for the at least one user equipment is increased to reach the seventh predetermined value requirement.

Taking that the transmission configuration parameter(s) are the number of the physical resource blocks and/or the modulation scheme allocated to uplink transmission for the user equipment and the determined structure of the neural network is the number of neurons in the middle layer as an example, an association relationship between the transmission configuration parameter(s) and the structure of the neural network is explained below.

Without loss of generality, the association relationship may be extended to other transmission configuration parameter(s) with other neural network structure settings. An example of the association relationship may be that when the number of physical resource blocks allocated to uplink transmission for at least one user equipment satisfies a specific value requirement (denoted C1), the number of neurons of the middle layer is N1, the specific value requirement C1 has a correspondence with the number of neurons in the middle layer N1, for example, when the number of physical resource blocks allocated to uplink transmission for at least one user equipment falls in a value range [1,49], the number of neurons of the middle layer is M1; when the number of physical resource blocks allocated to uplink transmission for at least one user equipment falls in a value range [50,100], the number of neurons of the middle layer is M2. According to an embodiment of this disclosure, M2>M1, i.e., the neural network should increase the number of neurons in the middle layer when the number of physical resource blocks allocated to uplink transmission for at least one user equipment increases, thereby matching the complexity of the optimization problem.

For another example, when a modulation order of the modulation scheme allocated to the uplink transmission for at least one user equipment satisfies a specific value requirement (denoted as C2), the number of neurons in the middle layer is N2, and the specific value requirement C2 has a correspondence with the number of neurons in the middle layer N2, e.g., when the modulation scheme allocated to the uplink transmission for at least one user equipment is 256QAM (modulation order of 8), the number of neurons of the middle layer is L1; when the modulation scheme allocated to the uplink transmission for at least one user equipment is 1024QAM (modulation order of 10), the number of neurons of the middle layer is L2. According to an embodiment of this disclosure, L2>L1, i.e., the neural network should increase the number of neurons in the middle layer when the order of the modulation scheme allocated to the uplink transmission for at least one user equipment increases, thereby matching the complexity of the optimization problem.

For yet another example, when the number of physical resource blocks configured to uplink transmission for at least one user equipment satisfies a specific value requirement (denoted as C3) and the modulation order of the modulation scheme allocated to uplink transmission for at least one user equipment satisfies a specific value requirement (denoted as C4), the number of neurons in the middle layer is N3, and the combination [C3, C4] of the specific value requirements has a correspondence with the number of neurons in the middle layer N3, in a similar way, the neural network should increase the number of neurons in the middle layer when the modulation order of the modulation scheme allocated to the uplink transmission for at least one user equipment increases or the number of physical resource blocks allocated to the uplink transmission for at least one user equipment increases, thereby matching the complexity of the optimization problem.

Without loss of generality, the transmission configuration parameter(s) in the above example may be replaced by one or a combination of multiple of the system bandwidth for uplink, the subcarrier spacing for uplink, the number of FFT points for uplink, the number of users with uplink transmissions on a same time unit, the number of layers/antenna ports configured to uplink transmission for at least one user equipment, the number of physical resource blocks allocated to uplink transmission for at least one user equipment, the modulation order of the modulation scheme configured to uplink transmission for the at least one user equipment. The neural network structure settings may be replaced by one or a combination of multiple of the number of middle layers of the neural network, the number of neurons of the middle layer of the neural network, and the buffer length of the input data.

For another example, in a case where the neural network is located in a base station side receiver, the number of middle layers of the neural network is reduced, and/or the number of neurons of the middle layer of the neural network is reduced, and/or the buffer length of the input data is reduced according to the transmission configuration parameter(s) when the transmission configuration parameter(s) satisfy at least one of the following conditions: the system bandwidth for uplink is reduced to reach the first predetermined value requirement; the subcarrier spacing for uplink is increased to reach the second predetermined value requirement; the number of the FFT points for uplink is reduced to reach the third predetermined value requirement; the number of users with uplink transmissions on a same time unit is reduced to reach the fourth predetermined value requirement; the number of the layers/antenna ports configured to uplink transmission for the at least one user equipment is reduced to reach the fifth predetermined value requirement; the number of the physical resource blocks allocated to uplink transmission for the at least one user equipment is reduced to reach the sixth predetermined value requirement; the modulation order of the modulation scheme configured to uplink transmission for the at least one user equipment is reduced to reach the seventh predetermined value requirement.

Similarly, in the above example, “uplink” may be replaced by “downlink”, i.e., the transmission configuration parameter(s) may also be replaced by a system bandwidth for downlink, a subcarrier spacing for downlink, the number of FFT points for downlink, the number of layers/antenna ports configured to downlink transmission for a user equipment, the number of physical resource blocks allocated to downlink transmission for a user equipment, a modulation scheme configured to downlink transmission for a user equipment.

Accordingly, according to an embodiment, According to an embodiment of this disclosure, the determining of the structure of the neural network based on the transmission configuration parameter(s) associated with the first signal as mentioned above may include: adjusting the structure of the neural network according to the transmission configuration parameter(s) when at least one of the following conditions is satisfied: the system bandwidth for downlink satisfies an eighth predetermined value requirement; the subcarrier spacing for downlink satisfies a ninth predetermined value requirement; the number of the FFT points for downlink satisfies a tenth predetermined value requirement; the number of the layers/antenna ports configured to downlink transmission for the user equipment satisfies an eleventh predefined value requirement; the number of the physical resource blocks allocated to downlink transmission for the user equipment satisfies a twelfth predetermined value requirement; the number of modulation orders of the modulation scheme configured to downlink transmission for the user equipment satisfies a thirteenth predefined value requirement.

For example, in a case where the neural network is located in a terminal side receiver, the number of middle layers of the neural network is increased, and/or the number of neurons in the middle layer of the neural network is increased, and/or the buffer length of the input data is increased according to the transmission configuration parameter(s) when the transmission configuration parameter(s) satisfy at least one of the following conditions: the system bandwidth for downlink is increased to reach the eighth predetermined value requirement; the subcarrier spacing for downlink is reduced to reach the ninth predetermined value requirement; the number of the FFT points for downlink is increased to reach the tenth predetermined value requirement; the number of layers/antenna ports configured to downlink transmission for the user equipment is increased to reach the eleventh predefined value requirement; the number of physical resource blocks allocated to downlink transmission for the user equipment is increased to reach the twelfth predefined value requirement; the modulation order of the modulation scheme configured to downlink transmission for the user equipment is increased to reach the thirteenth predefined value requirement.

For another example, in a case where the neural network is located in a terminal side receiver, the number of middle layers of the neural network is reduced, and/or the number of neurons of the middle layer of the neural network is reduced, and/or the buffer length of the input data is reduced according to the transmission configuration parameter(s) when the transmission configuration parameter(s) satisfy at least one of the following conditions: the system bandwidth for downlink is reduced to reach the eighth predetermined value requirement; the subcarrier spacing for downlink is increased to reach the ninth predetermined value requirement; the number of the FFT points for downlink is reduced to reach the tenth predefined value requirement; the number of layers/antenna ports configured to downlink transmission for the user equipment is reduced to reach the eleventh predefined value requirement; the number of physical resource blocks allocated to downlink transmission for the user equipment is reduced to reach the twelfth predefined value requirement; the modulation order of the modulation scheme configured to downlink transmission for the user equipment is reduced to reach the thirteenth predefined value requirement.

It is noted that the conditions for adjusting the neural network according to the transmission configuration parameter(s) may be different for a UE side and a base station side.

According to an embodiment, the neural network may include an input layer, the middle layer and an output layer, for example, as shown in FIG. 4b. According to an embodiment of this disclosure, the above method performed by the receiver may further include: determining an input matrix of the input layer and/or a transition matrix of the middle layer.

For example, when an ESN is employed as a neural network for non-linear compensation in a base station or terminal receiver, the determining of the structure of the neural network based on the transmission configuration parameter(s) may include: determining the number of neurons of the middle layer of the neural network, and/or the buffer length of the input data based on the transmission configuration parameter(s).

As shown in FIG. 4b, adaptive adjustment of the structure of the middle layer of the neural network is achieved by adjusting the number of neurons of the middle layer (i.e., adjusting the dimension of the transition matrix); and classification of the input data of the neural network is achieved by adjusting the buffer length of the input data (i.e., adjusting the dimension of the input matrix of the input layer of the ESN), e.g., the ESN processes non-linear compensation of the received data at moment t.

If non-linear features of the received data have certain time correlation, then a segment of data before and after moment t is cached as the input to the ESN, which helps to improve the performance of the neural network. Herein, the input matrix in the ESN is a fully connected matrix that satisfies row full rank or column full rank. Determining the input matrix means determining all parameters of the input layer in the ESN, and its dimension is determined by the buffer length of the input data and the number of neurons in the middle layer.

For example, the dimension of the input matrix Wᵢₙ is N_{node}×2N_{buffer}, where N_{node} is the number of neurons of the middle layer, N_{buffer} is the buffer length of the input data, and each element of the input matrix Wᵢₙ is a random number generated with the same distribution; the transition matrix in the ESN is a sparse connection matrix satisfying full rank, and determining the transition matrix means determining all parameters of the middle layer of the ESN, and its dimension is determined by the number of neurons of the middle layer, for example, the dimension of the transition matrix Wᵢₙ is N_{node}×N_{node}, where N_{node} is the number of neurons of the middle layer, and to control the computational complexity of the ESN, there is a general restriction on a sparse rate of elements of the transition matrix, for example, the sparse rate β of the transition matrix satisfies β≤10%, i.e., the number of non-zero elements is less than 10%, but it is still necessary to ensure that the transition matrix is full rank. The following will discuss how to determine the input matrix and the transition matrix in the ESN after adaptively adjusting the structure of the ESN according to the transmission configuration parameter(s).

According to an embodiment, in a case where the neural network is an ESN-based neural network, the above wireless communication method may also include: determining the input matrix of the input layer and/or the transition matrix of the middle layer in a table look-up, interception, or augmentation manner after determining or adjusting the number of neurons of the middle layer of the neural network, and/or the buffer length of the input data based on the configuration parameter(s) related to the input signal.

For the ESN, the input matrix should be a matrix with all elements of non-zero and full rank; the transition matrix should be a matrix with a sparse rate β of elements satisfying a requirement (e.g., not greater than a threshold) and full rank.

According to an embodiment, the determining of the input matrix of the input layer and/or the transition matrix of the middle layer may include at least one of the following:
selecting, according to the determined number of the neurons of the middle layer of the neural network and/or the buffer length of the input data, one of pre-stored input matrices and/or transition matrices as the input matrix of the input layer and/or the transition matrix of the middle layer of the neural network;
intercepting, according to the determined number of the neurons of the middle layer of the neural network and/or the buffer length of the input data, some elements from the pre-stored input matrices and/or transition matrices to obtain the input matrix of the input layer and/or the transition matrix of the middle layer of the neural network;
obtaining the input matrix of the input layer and/or the transition matrix of the middle layer of the neural network by transforming and/or stitching a pre-stored base matrix, according to the determined number of the neurons of the middle layer of the neural network and/or the buffer length of the input data.

Specifically, a specific implementation of determining the input matrix in the table look-up manner may be to select, according to the determined number of neurons of the middle layer of the neural network and/or the buffer length of the input data, one of pre-stored matrices as the input matrix of the input layer of the neural network, wherein a rule of the selection is that the number of neurons of the middle layer and/or the buffer length of the input data have/has a correspondence with the dimension of the selected matrix; and a specific implementation of determining the transition matrix in the table look-up manner may be to select, according to the determined number of neurons of the middle layer, one of pre-stored matrices as the transition matrix of the input layer of the neural network, wherein a rule of the selection is that the number of neurons of the middle layer has a correspondence with the dimension of the selected matrix.

In a case of the input matrix, the rule of the selection may be that the matrix selected as the input matrix has the dimension of N_{node}×2N_{buffer} (or, as an alternative, the matrix selected as the input matrix has the dimension of 2N_{buffer}×N_{node}, the matrix with the dimension of N_{node}×2N_{buffer} obtained after the row and column transformation). According to an embodiment of this disclosure, the pre-stored matrices are a plurality of matrices of different dimensions. According to an embodiment of this disclosure, the input matrix and the transition matrix have different pre-stored matrices or groups of matrices. The advantage of determining the input matrix/transition matrix in the table look-up manner is that the optimal input matrices/transition matrices of different dimensions may be pre-stored separately, thereby trading storage capacity and complexity for improved performance of the neural network.

A specific implementation of determining the input matrix in the interception manner may be to intercept, according to the determined number of neurons of the middle layer and/or the buffer length of the input data, some elements from the pre-stored matrices to construct the input matrix of the input layer of the neural network;

A specific implementation of determining the transition matrix in the interception manner may be to intercept, according to the determined number of neurons of the middle layer and/or the buffer length of the input data, some elements from the pre-stored matrices to construct the transition matrix of the middle layer of the neural network.

According to an embodiment of this disclosure, the input matrix and the transition matrix have different pre-stored matrices. According to an embodiment of this disclosure, the number of rows and the number of columns of the pre-stored matrix are greater than the maximum values of the number of rows and the number of columns of the input matrix (or, the transition matrix), respectively.

For the input matrix, let the dimension of the pre-stored matrix be N×M and the dimension of the input matrix be N_{node}×2N_{buffer}, then the dimension of the stored matrix satisfies N≥max(N_{node}) and M≥max(2N_{buffer}), where the function max(x) denotes the maximum value that may be achieved by the variable x;

For the transition matrix, let the dimension of the pre-stored matrix be N×M and the dimension of the transition matrix be N_{node}×N_{node}, then the dimension of the stored matrix satisfies N≥max(N_{node}) and M≥max(N_{node}), where the function max(x) denotes the maximum value that may be achieved by the variable x. The advantage of this approach is that it has low implementation complexity, requires little storage capacity, and may support the determination of input matrices/transition matrices of multiple dimensions.

Specifically, the interception rule may be to intercept some elements of the pre-stored matrix as elements of the input matrix (or, transition matrix) at specific positions, wherein the row and column positions of the elements in the pre-stored matrix have a one-to-one correspondence with the row and column positions of the elements in the input matrix, e.g., intercepting the element of the i-th row and j-th column of the pre-stored matrix as the element of the i-th row and j-th column of the input matrix (or, transition matrix).

For another example, taking the input matrix as an example, let the dimension of the pre-stored matrix be N×M and the dimension of the input matrix be N_{node}×2N_{buffer}, and starting from the element (i₀, j₀ in the pre-stored matrix, the N_{node} rows and 2N_{buffer} columns are intercepted as the input matrix, i.e., the elements of the input matrix

$${W}_{i n} = \{ {w}_{i , j} \vert {w}_{i , j} = {a}_{{i}_{0} + i - 1 , {j}_{0} + j - 1} ; i = 1 , … , {N}_{node} and i = 1 , … , 2 {N}_{buffer} \} ,$$

where α_{x,y} is the element of the xth row and yth column in the pre-stored matrix, and i₀ and j₀ may be fixed values, such as i₀=j₀=1.

In addition, a specific example of determining the input matrix in the interception manner may also be to select, based on a Mask matrix, a particular element of the pre-stored matrix as the input matrix (or, transition matrix), wherein the Mask matrix means an identification matrix identifying whether each element of the stored matrix is used to determine the input matrix (or, transition matrix).

According to an embodiment of this disclosure, the input matrix and the transition matrix have different Mask matrices, and the Mask matrices are also pre-stored one or more matrices. Taking the input matrix as an example, a specific implementation may be that the Mask matrix elements are of the same dimension as the pre-stored matrix, noted as N×M.

An element of the i-th row and j-th column of the Mask matrix is zero indicates that an element of the i-th row and j-th column of the pre-stored matrix is not used to determine the input matrix; conversely, an element of the i-th row and j-th column of the Mask matrix is not zero indicates that an element of the i-th row and j-th column of the pre-stored matrix is used to determine the input matrix. The method for determining the input matrix may be that a j-th element of non-zero identified by the Mask matrix in the i-th row of the pre-stored matrix is used as the element of the i-th row and j-th column of the input matrix.

A specific implementation of determining the input matrix in the augmented manner may be to obtain the input matrix of the input layer of the neural network by transforming, stitching, etc. a pre-stored base matrix, according to the determined number of the neurons of the middle layer and/or the buffer length of the input data;

A specific implementation of determining the transition matrix in the augmented manner may be to obtain the transition matrix of the middle layer of the neural network by transforming, stitching, etc. a pre-stored base matrix, according to the determined number of the neurons of the middle layer.

According to an embodiment of this disclosure, the base matrix of the input matrix is different from the base matrix of the transition matrix, e.g., the base matrix of the input matrix has no non-zero elements, while the number of non-zero elements of the base matrix of the transition matrix satisfies a sparse rate not greater than a threshold value.

According to an embodiment of this disclosure, at least one of the following conditions is satisfied: the number of rows of the base matrix is less than the possible minimum of the number of rows of the input matrix (or, the transition matrix) and the number of columns of the base matrix is less than the possible minimum of the number of columns of the input matrix (or, the transition matrix).

For example, let the dimension of the base matrix be N×M and the dimension of the input matrix (or, the transition matrix) be L×K, then the dimension of the base matrix satisfies N≤min(L) and M≤min(K), where the function min(x) represents the minimum value that may be achieved by the variable x.

Further, a specific way in which the base matrix is transformed and stitched to obtain the input matrix (or, transition matrix) is that the input matrix (or, transition matrix) may comprise a block matrix, wherein each block unit has the same dimension as the base matrix, and each block unit may be obtained from the base matrix by one or more matrix transformations, wherein the matrix transformation includes at least one of the following: an elementary row transformation (exchange positions of elements of any two rows), an elementary column transformation (exchange positions of elements of any two columns), and position exchange of any two elements of a matrix.

The advantage of this implementation is that it requires low storage capacity of the base station/terminal device, the required matrix transformation and matrix stitching operations have low implementation complexity, and it may support the determination of the input matrix/transition matrix of multiple dimensions.

Further, a cyclic shift of any row/column of the base matrix may be achieved by the above matrix transformation, the cyclic shift of a matrix is a common transformation operation with low implementation complexity and does not change the matrix elements and matrix rank. Taking the cyclic shift of a row as an example, let the dimension of the base matrix be N×M, the cyclic shift of the i-th row of the base matrix with a length K may be realized by swapping the positions of elements several times: exchanging the positions of elements α_{i,j}and α_{i,j+M-K}, where j=1, . . . , K;

Taking the cyclic shift of a column as an example, let the dimension of the base matrix be N×M, the cyclic shift of the j-th row of the base matrix with a length K may be realized by swapping the positions of elements several times: exchanging the positions of elements α_{i+M-k,j} and α_{i,j}, where i=1, . . . , K.

Furthermore, the matrix transformation method performed by each block unit on the base matrix in the process of determining the input matrix (or, transition matrix) may be different, and a specific implementation may be that the matrix transformation method performed by each block unit on the base matrix is determined according to an extended matrix L, and an element l_{i,j} of the i-th row and j-th column of the extended matrix L indicates a type of matrix transformation performed by a block unit con-stituting the i-th row and j-th column of the input matrix on the base matrix A.

For example, the value of l_{i,j} may be a cyclic shift of a length l_{i,j} to the base matrix, and the matrix of the base matrix after the cyclic shift is noted as A(l_{i,j}), then the block unit of the i-th row and j-th column of the input matrix is A (l_{i,j}).

Taking an example of constructing the input matrix, let the dimension of the input matrix be 8×4 and the dimension of the base matrix A be 4×2, then the selected extended matrix L has a dimension of 2×2 and is used to extend the base matrix A to form the input matrix with a dimension of 8×4. The block unit of the i-th row and j-th column of the input matrix is noted as A (l_{i,j}), and the input matrix obtained by the extension is

$$[ \begin{matrix}A ( {l}_{1 , 1} ) & A ( {l}_{1 , 2} ) \\ A ( {l}_{2 , 1} ) & A ( {l}_{2 , 2} )\end{matrix} ] .$$

According to an embodiment of this disclosure, the extended matrix L may be one or more pre-stored matrices, and one of the pre-stored extended matrices may be selected for generating the input matrix (or, transition matrix) based on the dimension of the extended matrix L, wherein the dimension of the selected extended matrix L is determined by the dimension of the input matrix (or, transition matrix) and the dimension of the base matrix. According to an embodiment of this disclosure, the extended matrices used to determine the input matrix and the transition matrix may be different pre-stored matrices or groups of matrices.

In practice, there may be cases where the number of rows of the input matrix (or transition matrix) is not an integer multiple of the number of rows of the base matrix; or the number of columns of the input matrix (or transition matrix) is not an integer multiple of the number of columns of the base matrix, in the cases, the input matrix (or transition matrix) may be obtained by first extending and then intercepting. Take the input matrix as an example, the dimension of the input matrix is 6×4, and the dimension of the base matrix A is 4×2, a matrix of dimension 8×4 may be constructed by augmentation, and then 6 rows of it are intercepted to get the input matrix.

The specific augmentation method and interception method may be as described in the above embodiments. The input matrix of the input layer and/or the transition matrix of the middle layer determined in the above manner are used to perform the non-linear compensation for the input signal (i.e., the multiple second signals) of the neural network.

According to an embodiment of the present disclosure, the neural network may include a plurality of parallel neural networks. According to an embodiment of this disclosure, when the multiple second signals are uplink signals of different uplink transmission layers of different user equipments, the uplink signal of each uplink transmission layer of different user equipments may be performed the non-linear compensation by different parallel neural networks respectively, or the uplink signals of all uplink transmission layers of each user equipment may be performed the non-linear compensation by a same parallel neural network, or the uplink signals of a same modulation scheme of different transmission layers for uplink of different user equipments may be performed the non-linear compensation by the same parallel neural network.

According to an embodiment of this disclosure, the multiple second signals are downlink signals of different downlink transmission layers of a same user equipment, the downlink signal of each downlink transmission layer of the same user equipment may be performed the non-linear compensation by different parallel neural networks respectively, or the downlink signals of a same modulation scheme of different transmission layers for downlink of the same user equipment may be performed the non-linear compensation by the same parallel neural network.

According to an embodiment of the present disclosure, in a case where the neural network is located in a base station side receiver, the determining or adjusting of the structure of the neural network based on the transmission configuration parameter(s) may include: determining the number of neural networks based on at least one of the number of users with uplink transmissions on a same time unit, the number of layers/antenna ports configured to uplink transmission for at least one user equipment, the modulation scheme configured to uplink transmission for at least one user equipment.

For example, the number of neural networks may comprise the number of parallel neural networks. The inputs and outputs of any two parallel neural networks are independent of each other and are trained independently.

According to an embodiment of this disclosure, the number of parallel neural networks is determined based on the number Nᵤ of users with uplink transmissions on a same time unit and the number Nₗ(iᵤ), iᵤ=1, . . . , Nᵤ of layers/antenna ports configured to uplink transmission for each user equipment, e.g., each layer of data for each user equipment is processed by a separate parallel neural network, i.e., the number of parallel neural networks is

$${\sum }_{{i}_{u} = 1}^{{N}_{u}} {N}_{l} ( {i}_{u} ) .$$

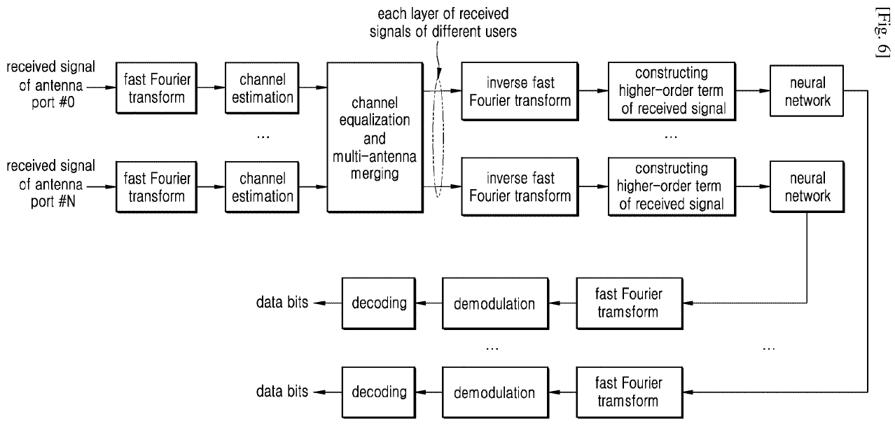

FIG. 6 illustrates a schematic diagram of a base station side receiver where each layer of uplink signals from different user equipments is processed by different parallel neural networks, respectively.

According to an embodiment of this disclosure, the number of neural networks may be determined based on the number Nᵤ of users with uplink transmissions on a same time unit, e.g., all layers of data of each user equipment are processed by separate parallel neural networks respectively, i.e., the number of parallel neural networks is Nᵤ, in the case, the input of each parallel neural network is the uplink signals of all layers of the same user equipment.

The advantage of this design is that each parallel neural network only needs to process a small amount of data, so the structure of each parallel neural network may be simple (e.g., few neurons in the middle layer), thus reducing the overall complexity of the receiver; and when the non-linear features of the uplink signals of different layers of different user equipments are independent and the interference between them is small, the structure of multiple parallel neural networks may theoretically achieve similar performance to that of a single (larger) neural network.

According to an embodiment of this disclosure, the number of parallel neural networks may be determined based on the number N_{M} of types of modulation schemes configured to uplink transmissions for at least one user equipment, e.g., received data streams of the same modulation of different layers of different user equipments are processed by the same parallel neural network, and received data streams of different modulation schemes are processed by another parallel neural network, i.e., the number of parallel neural networks is N_{M}, in the case, the input of each parallel neural network may be the uplink signal of the same modulation scheme from the same or different users.

The advantage of this design is that each parallel neural network only needs to process the received signals of the same modulation scheme, and since the complexity of the non-linear features of the received signals of different modulation schemes is different (e.g., the non-linear distortion of 1024QAM signals is greater than that of 256QAM signals), the parallel neural networks may be optimized separately by considering using different parallel neural networks to process signals of different modulation schemes, thereby reducing the overall complexity of the receiver; and when the non-linear features of the uplink signals of different layers of different user equipments are independent and the interference between them is small, the structure of multiple parallel neural networks may theoretically achieve similar performance to that of a single (larger) neural network.

Similarly, in the above example, “uplink” may be replaced with “downlink”. For example, in a case where the neural network is located in a terminal side receiver, the determining of the structure of the neural network based on the transmission configuration parameter(s) mentioned above may include determining the number of neural networks based on at least one of the number of layers/antenna ports configured to downlink transmission for the user equipment, the modulation scheme configured to the downlink transmission for the user equipment.

Similarly, the number of the neural networks may be the number of parallel neural networks. The inputs and outputs of any two parallel neural networks are independent of each other and are trained independently. According to an embodiment of this disclosure, the number of neural networks is determined based on the number N, of layers/antenna ports configured to downlink transmission for the user equipment, e.g., each layer of data of the user equipment is processed by a separate neural network, i.e., the number of parallel neural networks is Nₗ.

As described above, the neural network may include a plurality of parallel neural networks. Further, to enhance the performance of the structure of the parallel neural network, such as to handle interference between the input data of the parallel neural networks, etc., a feedback link may be introduced between the parallel neural networks, i.e., the output of at least one parallel neural network is used as an input to another parallel neural network, e.g., the output of one of the parallel neural networks is used as input data or part of the input data of another neural network.

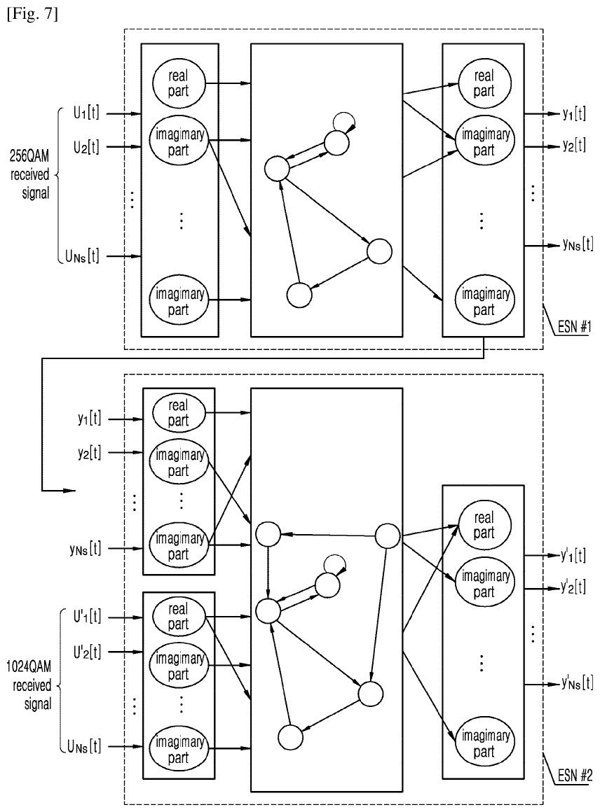

According to an embodiment of this disclosure, this structure may be applied when the base station/terminal receiver needs to simultaneously receive signals with different non-linear features, e.g., different modulation schemes, for example, a part of the multiple received signals are signals using 256QAM and another part are signals using 1024QAM. The following is an example that a parallel neural network is an ESN to illustrate a specific implementation of a parallel neural network with a feedback link, as shown in FIG. 7.

Let the receiver receive two modulated signals 256QAM and 1024QAM in the same time unit, where the degree of non-linear distortion (EVM) of the 256QAM signal is smaller than that of 1024QAM signal, the non-linear compensation for the 256QAM received signal may be handled by an independent parallel neural network ESN #1, where the input signal of ESN #1 is the output of the multiple received signals using 256QAM passing through the module of “constructing a higher-order term of a received signal” (as shown in FIG. 6), and the non-linear compensation for the 1024QAM received signal is handled by another parallel neural network ESN #2, where the input signal of ESN #2 is two parts: one part is the output of the multiple received signals using 1024QAM passing through the module of “constructing a higher-order term of a received signal” (as shown in FIG. 6); the other part is the output of ESN #1.

The advantage of this design is that it inherits the advantage of parallel neural network design: the structure of each parallel neural network may be optimized separately to greatly reduce the complexity of implementation while ensuring the performance, and the correlation (e.g., interference, etc.) between the processed data may be taken into account: a single output by one parallel neural network after the non-linear compensation is used as part of input data of another parallel neural network, so that the another parallel neural network may handle the interference between the part of input data and another part of data to a certain extent when processing the non-linear compensation for the another part of data, improving the non-linear compensation performance of the another parallel neural network.

According to an embodiment of this disclosure, the output of the parallel neural network processing the 256QAM signal is used as the input of the parallel neural network processing the 1024QAM signal. The reason is that the 256QAM signal has less non-linear distortion compared to the 1024QAM signal, and the non-linear compensation for the output of the parallel neural network is more accurate, so it may be used as the input of another parallel neural network to avoid the increase of error.

According to an embodiment of this disclosure, another way to further enhance the performance of the structure of the parallel neural network may be that at least one of input signals is split and multiplexed between parallel neural networks, i.e., the input of each parallel neural network is at least one of the multiple second signals, and the at least one of the multiple second signals is input to two different parallel neural networks, e.g., data A and data B are used as input to one of the parallel neural networks (denoted as neural network #1), while the data A is also used as input data to another neural network (denoted as neural network #2).

This design may be applied to scenarios when the correlation between the data A and the data B is not equivalent, e.g., processing of the data A is not much related to the data B, but processing of the data B is highly interfered by the data A, e.g., the data A is received data of 256 QAM and the data B is received data of 1024 QAM; or, the data A is an uplink received signal of a user equipment with good channel conditions (low transmitting power, low non-linear distortion), and the data B is an uplink received signal of a user equipment with poor channel conditions (high transmitting power, high non-linear distortion).

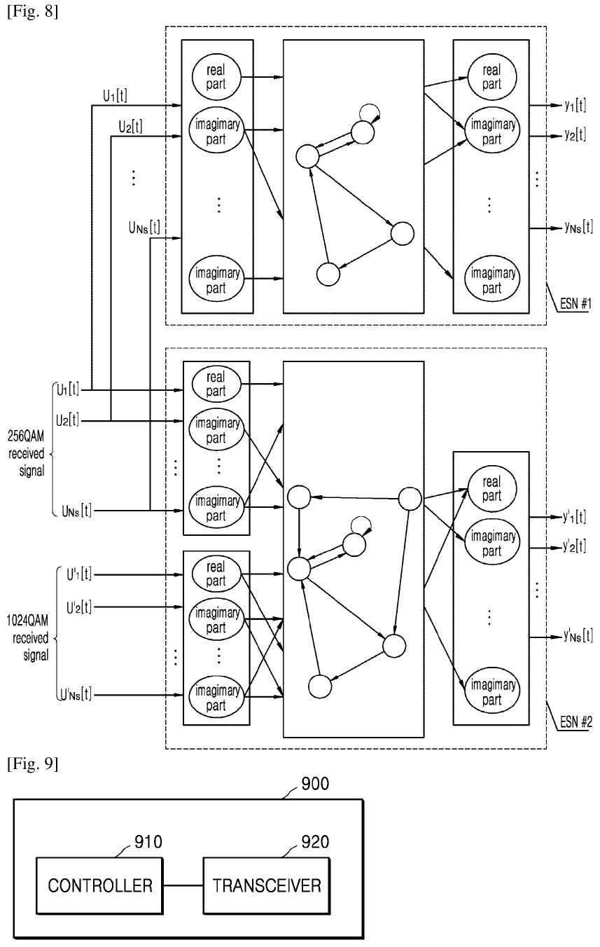

The improvement of the parallel neural networks as above may improve the performance of each neural network by taking into account the interference between different data and selecting appropriate input data for each parallel neural network on the basis of inheriting the advantage of the parallel neural networks. The following is an example of an ESN to illustrate a specific implementation of parallel neural networks with input data splitting and multiplexing, as shown in FIG. 8.

It is assumed that the receiver simultaneously receives two modulated signals 256QAM and 1024QAM in the same time unit, where the degree of non-linear distortion (EVM) of the 256QAM signal is smaller than that of 1024QAM, the non-linear compensation for the 256QAM received signal may be handled by an independent parallel neural network ESN #1, where the input signal of ESN #1 is the output of the multiple received signals using 256QAM passing through the module of “constructing a higher-order term of a received signal” (as shown in FIG. 6), and the non-linear compensation for the 1024QAM received signal is handled by another parallel neural network ESN #2, where the input signal of ESN #2 is two parts: one part is the output of the multiple received signals using 256QAM passing through the module of “constructing a higher-order term of a received signal” (as shown in FIG. 6); the other part is the output of the multiple received signals using 1024QAM passing through the module of “constructing a higher-order term of a received signal” (as shown in FIG. 6).

After determining the structure of the neural network based on the transmission configuration parameter(s), the neural network with the determined structure may be used to perform the non-linear compensation for the multiple second signals. As an example, the neural network is an ESN-based neural network, which includes an input layer, an middle layer, and an output layer.

Specifically, for example, the multiple second signals are transformed by an input matrix of the input layer as the input of the middle layer, and the middle layer performs various complex operations on its input data, such as generating a state vector of the middle layer after passing through a transition matrix of the middle layer, and finally, the output state vector of the middle layer is used as the input of the output layer of the neural network, and the output layer performs a matrix transformation on the state vector of the middle layer, and finally outputs a non-linearly compensated time domain received signal after non-linear compensation. Since the process of non-linear compensation has been described above with reference to FIG. 4b, the details of it are not repeated here, and the corresponding contents may refer to the above description.

Although the non-linear compensation of the neural network has been described above with the ESN as an example, the neural network of the embodiments of the present disclosure is not limited to this, but may also include, but not limited to, convo-lutional neural networks (CNN), deep neural networks (DNN), recurrent neural networks (RNN), restricted Boltzmann machines (RBM), deep confidence networks (DBN), bidirectional recurrent deep neural networks (BRDNN), generative adversarial network (GAN), and deep Q-network.

The above has described the wireless communication method according to the embodiments of the present disclosure, according to which the structure of the neural network may be determined according to the transmission configuration parameter(s), so that the self-adaption of the structure of the neural network may be realized, thereby achieving a reasonable compromise between the complexity and the performance of the neural network, and avoiding the reduction of the neural network performance caused by the training overfitting.

FIG. 9 illustrates a block diagram of a wireless communication device according to an embodiment of the present disclosure.

Referring to FIG. 9, the wireless communication device 900 may include at least one controller 910 and a transceiver 920. Specifically, the at least one controller 910 may be coupled to the transceiver 920 and configured to perform the above method mentioned in the description of FIG. 5. The details of the operations involved in the above method may refer to the description of FIG. 5, and will not be repeated here. According to the embodiments, the wireless communication device 900 may be a receiver of a base station side, a terminal side, a side link device side, or a relay node in a communication link, or a wireless communication device including the above receiver.

According to an embodiment of the present disclosure, a computer readable storage medium storing instructions is also provided. The instructions, when executed by at least one processor, causes the at least one processor to perform the methods according to the embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs.

The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

According to a first aspect of the embodiments of the present disclosure, there is proposed a method performed by a receiver in a wireless communication system, including: receiving a first signal, and obtaining multiple second signals based on the received first signal; performing non-linear compensation for the multiple second signals based on a neural network to obtain a third signal; obtaining data bits based on the third signal; wherein a structure of the neural network is determined based on transmission configuration parameter(s) associated with the first signal.

Alternatively, the method further includes: determining the structure of the neural network based on the transmission configuration parameter(s) associated with the first signal, wherein the performing of the non-linear compensation for the multiple second signals based on the neural network to obtain the third signal includes: performing the non-linear compensation for the multiple second signals by using the neural network with the determined structure, to obtain the third signal.

Alternatively, the structure of the neural network includes at least one of: the number of neural networks, the number of middle layers of the neural network, the number of neurons of the middle layer of the neural network, and a buffer length of input data of the neural network.

Alternatively, the transmission configuration parameter(s) includes at least one of: a system bandwidth for uplink, a subcarrier spacing for uplink, the number of Fast Fourier Transform (FFT) points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment.

Alternatively, the transmission configuration parameter(s) includes at least one of: a system bandwidth for downlink, a subcarrier spacing for downlink, the number of Fast Fourier Transform (FFT) points for downlink, the number of layers/antenna ports configured to downlink transmission for a user equipment, the number of physical resource blocks configured to downlink transmission for a user equipment, a modulation scheme configured to downlink transmission for a user equipment.

Alternatively, the determining of the structure of the neural network based on the transmission configuration parameter(s) associated with the first signal includes: determining the structure of the neural network based on the transmission configuration parameter(s) when at least one of the following conditions is satisfied: the system bandwidth for uplink satisfies a first predetermined value requirement; the subcarrier spacing for uplink satisfies a second predetermined value requirement; the number of the FFT points for uplink satisfies a third predetermined value requirement; the number of users with uplink transmissions on a same time unit satisfies a fourth predetermined value requirement; the number of the layers/antenna ports configured to uplink transmission for the at least one user equipment satisfies a fifth predetermined value requirement; the number of the physical resource blocks allocated to uplink transmission for the at least one user equipment satisfies a sixth predetermined value requirement; a modulation order of the modulation scheme configured to uplink transmission for the at least one user equipment satisfies a seventh predetermined value requirement.

Alternatively, the determining of the structure of the neural network based on the transmission configuration parameter(s) associated with the first signal includes: adjusting the structure of the neural network according to the transmission configuration parameter(s) when at least one of the following conditions is satisfied: the system bandwidth for downlink satisfies an eighth predetermined value requirement; the subcarrier spacing for downlink satisfies a ninth predetermined value requirement; the number of the FFT points for downlink satisfies a tenth predetermined value requirement; the number of the layers/antenna ports configured to downlink transmission for the user equipment satisfies an eleventh predefined value requirement; the number of the physical resource blocks allocated to downlink transmission for the user equipment satisfies a twelfth predetermined value requirement; a modulation order of the modulation scheme configured to downlink transmission for the user equipment satisfies a thirteenth predefined value requirement.

Alternatively, the neural network includes an input layer, the middle layer, and an output layer, wherein the method further includes: determining an input matrix of the input layer and/or a transition matrix of the middle layer; wherein the determining of the input matrix of the input layer and/or the transition matrix of the middle layer includes at least one of: selecting, according to the determined number of the neurons of the middle layer of the neural network and/or the buffer length of the input data, one of pre-stored input matrices and/or transition matrices as the input matrix of the input layer and/or the transition matrix of the middle layer of the neural network; intercepting, according to the determined number of the neurons of the middle layer of the neural network and/or the buffer length of the input data, some elements from the pre-stored input matrices and/or transition matrices to obtain the input matrix of the input layer and/or the transition matrix of the middle layer of the neural network; obtaining the input matrix of the input layer and/or the transition matrix of the middle layer of the neural network by transforming and/or stitching a pre-stored base matrix, according to the determined number of the neurons of the middle layer of the neural network and/or the buffer length of the input data.

Alternatively, the neural network includes a plurality of parallel neural networks, wherein when the multiple second signals are uplink signals of different uplink transmission layers of different user equipments, the uplink signal of each uplink transmission layer of different user equipments is performed the non-linear compensation by different parallel neural networks respectively, or the uplink signals of all uplink transmission layers of each user equipment are performed the non-linear compensation by a same parallel neural network, or the uplink signals of a same modulation scheme of different transmission layers for uplink of different user equipments are performed the non-linear compensation by the same parallel neural network; when the multiple second signals are downlink signals of different downlink transmission layers of a same user equipment, the downlink signal of each downlink transmission layer of the same user equipment is performed the non-linear compensation by different parallel neural networks respectively, or the downlink signals of a same modulation scheme of different transmission layers for downlink of the same user equipment are performed the non-linear compensation by the same parallel neural network.

Alternatively, the neural network includes a plurality of parallel neural networks, wherein an output of at least one parallel neural network is used as an input of another parallel neural network; or an input of each parallel neural network is at least one second signal of the multiple second signals, the at least one second signal being input to two different parallel neural networks.

Alternatively, the transmission configuration parameter(s) includes at least one of: a system bandwidth for side link, a subcarrier spacing for side link, the number of fast Fourier transform (FFT) points for side link, the number of layers/antenna ports configured to side link transmission for a side link user equipment, the number of physical resource blocks configured to side link transmission for a side link user equipment and a modulation scheme configured to side link transmission for a side link user equipment.

According to a second aspect of the embodiments of the present disclosure, there is proposed a wireless communication device, including: a transceiver; and at least one controller coupled to the transceiver and configured to perform the following op-crations of: receiving a first signal, and obtaining multiple second signals based on the received first signal; performing non-linear compensation for the multiple second signals based on a neural network to obtain a third signal; obtaining data bits based on the third signal; wherein a structure of the neural network is determined based on transmission configuration parameter(s) associated with the first signal.

Alternatively, the at least one controller is further configured to determine the structure of the neural network based on the transmission configuration parameter(s) associated with the first signal, wherein the performing of the non-linear compensation for the multiple second signals based on the neural network to obtain the third signal includes: performing the non-linear compensation for the multiple second signals by using the neural network with the determined structure, to obtain the third signal.

Alternatively, the structure of the neural network includes at least one of: the number of neural networks, the number of middle layers of the neural network, the number of neurons of the middle layer of the neural network, and a buffer length of input data of the neural network.

Alternatively, the transmission configuration parameter(s) includes at least one of: a system bandwidth for uplink, a subcarrier spacing for uplink, the number of Fast Fourier Transform (FFT) points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment.

Alternatively, the transmission configuration parameter(s) includes at least one of: a system bandwidth for downlink, a subcarrier spacing for downlink, the number of Fast Fourier Transform (FFT) points for downlink, the number of layers/antenna ports configured to downlink transmission for a user equipment, the number of physical resource blocks configured to downlink transmission for a user equipment, a modulation scheme configured to downlink transmission for a user equipment.

Alternatively, the determining of the structure of the neural network based on the transmission configuration parameter(s) associated with the first signal includes: determining the structure of the neural network based on the transmission configuration parameter(s) when at least one of the following conditions is satisfied: the system bandwidth for uplink satisfies a first predetermined value requirement; the subcarrier spacing for uplink satisfies a second predetermined value requirement; the number of the FFT points for uplink satisfies a third predetermined value requirement; the number of users with uplink transmissions on a same time unit satisfies a fourth predetermined value requirement; the number of the layers/antenna ports configured to uplink transmission for the at least one user equipment satisfies a fifth predetermined value requirement; the number of the physical resource blocks allocated to uplink transmission for the at least one user equipment satisfies a sixth predetermined value requirement; a modulation order of the modulation scheme configured to uplink transmission for the at least one user equipment satisfies a seventh predetermined value requirement.

Alternatively, the determining of the structure of the neural network based on the transmission configuration parameter(s) associated with the first signal includes: adjusting the structure of the neural network according to the transmission configuration parameter(s) when at least one of the following conditions is satisfied: the system bandwidth for downlink satisfies an eighth predetermined value requirement; the subcarrier spacing for downlink satisfies a ninth predetermined value requirement; the number of the FFT points for downlink satisfies a tenth predetermined value requirement; the number of the layers/antenna ports configured to downlink transmission for the user equipment satisfies an eleventh predefined value requirement; the number of the physical resource blocks allocated to downlink transmission for the user equipment satisfies a twelfth predetermined value requirement; a modulation order of the modulation scheme configured to downlink transmission for the user equipment satisfies a thirteenth predefined value requirement.

Alternatively, the neural network includes an input layer, the middle layer, and an output layer, wherein the at least one controller is further configured to: determine an input matrix of the input layer and/or a transition matrix of the middle layer; wherein the determining of the input matrix of the input layer and/or the transition matrix of the middle layer includes at least one of: selecting, according to the determined number of the neurons of the middle layer of the neural network and/or the buffer length of the input data, one of pre-stored input matrices and/or transition matrices as the input matrix of the input layer and/or the transition matrix of the middle layer of the neural network; intercepting, according to the determined number of the neurons of the middle layer of the neural network and/or the buffer length of the input data, some elements from the pre-stored input matrices and/or transition matrices to obtain the input matrix of the input layer and/or the transition matrix of the middle layer of the neural network; obtaining the input matrix of the input layer and/or the transition matrix of the middle layer of the neural network by transforming and/or stitching a pre-stored base matrix, according to the determined number of the neurons of the middle layer of the neural network and/or the buffer length of the input data.

Alternatively, the neural network includes a plurality of parallel neural networks, wherein when the multiple second signals are uplink signals of different uplink transmission layers of different user equipments, the uplink signal of each uplink transmission layer of different user equipments is performed the non-linear compensation by different parallel neural networks respectively, or the uplink signals of all uplink transmission layers of each user equipment are performed the non-linear compensation by a same parallel neural network, or the uplink signals of a same modulation scheme of different transmission layers for uplink of different user equipments are performed the non-linear compensation by the same parallel neural network; when the multiple second signals are downlink signals of different downlink transmission layers of a same user equipment, the downlink signal of each downlink transmission layer of the same user equipment is performed the non-linear compensation by different parallel neural networks respectively, or the downlink signals of a same modulation scheme of different transmission layers for downlink of the same user equipment are performed the non-linear compensation by the same parallel neural network.

Alternatively, the neural network includes a plurality of parallel neural networks, wherein an output of at least one parallel neural network is used as an input of another parallel neural network; or an input of each parallel neural network is at least one second signal of the multiple second signals, the at least one second signal being input to two different parallel neural networks.

Alternatively, the transmission configuration parameter(s) includes at least one of: a system bandwidth for side link, a subcarrier spacing for side link, the number of fast Fourier transform (FFT) points for side link, the number of layers/antenna ports configured to side link transmission for a side link user equipment, the number of physical resource blocks configured to side link transmission for a side link user equipment and a modulation scheme configured to side link transmission for a side link user equipment.

According to a third aspect of the embodiments of the present disclosure, there is proposed a computer readable storage medium storing instructions, wherein the instructions, when run by at least one processor, cause the at least one processor to perform the above method.

Other embodiments of the present disclosure will readily be conceived by those skills in the art after considering the specification and practicing the invention disclosed herein. The present disclosure is intended to cover any variation, use, or adaptation of the present disclosure that follows the general principle of the present disclosure and includes commonly known or customary technical means in the art not disclosed herein. The specification and embodiments are to be considered exemplary only, and the true scope and spirit of the disclosure is limited by the claims.

1. A method performed by a receiver in a wireless communication system, comprising:
receiving a first signal;
obtaining multiple second signals comprising at least one higher order term of the first signal, based on the received first signal;
determining, based on transmission configuration information associated with the first signal, a structure of at least one neural network;
performing non-linear compensation for the multiple second signals based on the neural network to obtain a third signal; and
obtaining data bits based on the third signal.

2. The method of claim 1, wherein the structure of the neural network comprises at least one of:
the number of the neural network, the number of one or more middle layers of the neural network, the number of neurons of the middle layer of the neural network, and a buffer length of input data of the neural network.

3. The method of claim 1, wherein the transmission configuration information comprises at least one of:
a system bandwidth for uplink, a subcarrier spacing for uplink, the number of Fast Fourier Transform (FFT) points for uplink, the number of users with uplink transmissions on a same time unit, the number of layers/antenna ports configured to uplink transmission for at least one user equipment, the number of physical resource blocks allocated to uplink transmission for at least one user equipment, a modulation scheme configured to uplink transmission for at least one user equipment.

4. The method of claim 1, wherein the transmission configuration information comprises at least one of:
a system bandwidth for downlink, a subcarrier spacing for downlink, the number of Fast Fourier Transform (FFT) points for downlink, the number of layers/antenna ports configured to downlink transmission for a user equipment, the number of physical resource blocks configured to downlink transmission for a user equipment, a modulation scheme configured to downlink transmission for a user equipment.

5. The method of claim 3, wherein the determining of the structure of the neural network based on the transmission configuration information associated with the first signal comprises:
adjusting the structure of the neural network based on the transmission configuration information in case that at least one of the following conditions is satisfied:
the system bandwidth for uplink satisfies a first predetermined value requirement;
the subcarrier spacing for uplink satisfies a second predetermined value requirement;
the number of the FFT points for uplink satisfies a third predetermined value requirement;
the number of users with uplink transmissions on a same time unit satisfies a fourth predetermined value requirement;
the number of the layers/antenna ports configured to uplink transmission for the at least one user equipment satisfies a fifth predetermined value requirement;
the number of the physical resource blocks allocated to uplink transmission for the at least one user equipment satisfies a sixth predetermined value requirement;
a modulation order of the modulation scheme configured to uplink transmission for the at least one user equipment satisfies a seventh predetermined value requirement.

6. The method of claim 4, wherein the determining of the structure of the neural network based on the transmission configuration information associated with the first signal comprises:
adjusting the structure of the neural network based on the transmission configuration information in case that at least one of the following conditions is satisfied:
the system bandwidth for downlink satisfies an eighth predetermined value requirement;
the subcarrier spacing for downlink satisfies a ninth predetermined value requirement;
the number of the FFT points for downlink satisfies a tenth predetermined value requirement;
the number of the layers/antenna ports configured to downlink transmission for the user equipment satisfies an eleventh predefined value requirement;
the number of the physical resource blocks allocated to downlink transmission for the user equipment satisfies a twelfth predetermined value requirement;
a modulation order of the modulation scheme configured to downlink transmission for the user equipment satisfies a thirteenth predefined value requirement.

7. The method of claim 2, wherein the neural network comprises an input layer, the one or more middle layer, and an output layer,
wherein the method further comprises:
determining an input matrix of the input layer;
wherein the determining of the input matrix of the input layer comprises at least one of:
selecting, based on at least one of the determined number of the neurons of the middle layer of the neural network and/or the buffer length of the input data, one of stored input matrices as the input matrix of the input layer of the neural network;
intercepting, based on the determined number of the neurons of the middle layer of the neural network and/or the buffer length of the input data, some elements from the stored input matrices and/or transition matrices to obtain the input matrix of the input layer of the neural network;
obtaining the input matrix of the input layer of the neural network by transforming and/or stitching a pre-stored base matrix based on the determined number of the neurons of the middle layer of the neural network and/or the buffer length of the input data.

8. The method of claim 2, wherein the neural network comprises an input layer, the one or more middle layer, and an output layer,
wherein the method further comprises:
determining a transition matrix of the middle layer;
wherein the determining of the transition matrix of the middle layer comprises at least one of:
selecting, based on at least one of the determined number of the neurons of the middle layer of the neural network and/or the buffer length of the input data, one of stored transition matrices as the transition matrix of the middle layer of the neural network;
intercepting, based on the determined number of the neurons of the middle layer of the neural network and/or the buffer length of the input data, some elements from the stored transition matrices to obtain the transition matrix of the middle layer of the neural network;
obtaining the transition matrix of the middle layer of the neural network by transforming and/or stitching a pre-stored base matrix, based on the determined number of the neurons of the middle layer of the neural network and/or the buffer length of the input data.

9. The method of claim 1, wherein the neural network comprises a plurality of parallel neural networks,
wherein, in case that the multiple second signals comprise uplink signals of different uplink transmission layers of different user equipments, the uplink signal of each uplink transmission layer of different user equipments is performed the non-linear compensation by different parallel neural networks respectively, or the uplink signals of all uplink transmission layers of same user equipment are performed the non-linear compensation by a same parallel neural network.

10. The method of claim 9, the uplink signals of a same modulation scheme of different transmission layers for uplink of different user equipments are performed the non-linear compensation by the same parallel neural network.

11. The method of claim 1, wherein the neural network comprises a plurality of parallel neural networks,
in case that the multiple second signals comprise downlink signals of different downlink transmission layers of a same user equipment, the downlink signal of each downlink transmission layer of the same user equipment is performed the non-linear compensation by different parallel neural networks respectively, or the downlink signals of a same modulation scheme of different transmission layers for downlink of the same user equipment are performed the non-linear compensation by the same parallel neural network.

12. The method of claim 1, wherein the neural network comprises a plurality of parallel neural networks,
wherein an output of at least one parallel neural network is used as an input of another parallel neural network; or an input of each parallel neural network comprises at least one second signal of the multiple second signals, the at least one second signal being input to two different parallel neural networks.

13. The method of claim 1, wherein the transmission configuration information comprises at least one of: a system bandwidth for side link, a subcarrier spacing for side link, the number of fast Fourier transform (FFT) points for side link, the number of layers/antenna ports configured to side link transmission for a side link user equipment, the number of physical resource blocks configured to side link transmission for a side link user equipment and a modulation scheme configured to side link transmission for a side link user equipment.

14. A wireless communication device comprising:
a transceiver;
at least one controller coupled to the transceiver and configured to:
receive a first signal;
obtain multiple second signals comprising at least one higher order term of the first signal, based on the received first signal;
determine, based on transmission configuration information associated with the first signal, a structure of at least one neural network;
perform non-linear compensation for the multiple second signals based on the neural network to obtain a third signal; and
obtain data bits based on the third signal.

15. A computer readable storage medium storing instructions, wherein the instructions, when run by at least one processor, cause the at least one processor to;
receive a first signal;
obtain multiple second signals comprising at least one higher order term of the first signal, based on the received first signal;
determine, based on transmission configuration information associated with the first signal, a structure of at least one neural network;
perform non-linear compensation for the multiple second signals based on the neural network to obtain a third signal; and
obtain data bits based on the third signal.
